(19) United States
(12) Patent Application Publication
(10) Pub. No.: US 2014/0129296 A1
(43) Pub. Date: May 8, 2014

(54) METHOD AND SYSTEM FOR OFFERING AND PROCURING WELL SERVICES

(71) Applicant: SCHLUMBERGER TECHNOLOGY CORPORATION, (US)

(72) Inventors: Irina Muraviyova, Houston, TX (US); Theodore Lafferty, Sugar Land, TX (US); Matthew J. Miller, Katy, TX (US); Humair Shaikh, Sugar Land, TX (US)

(73) Assignee: SCHLUMBERGER TECHNOLOGY CORPORATION, Sugar Land, TX (US)

(21) Appl. No.: 13/803,424

(22) Filed: Mar. 14, 2013

Related U.S. Application Data
(60) Provisional application No. 61/723,560, filed on Nov. 7, 2012.

(51) Int. Cl. G06Q 10/06

(52) U.S. Cl. CPC G06Q 10/06393
USPC 705/7.39

(57) ABSTRACT

A system for procuring well services for a location is disclosed. The system comprises a computer processor and memory; an input module stored in memory, executing on the computer processor, and configured to obtain a location data item comprising a geographic location; a processing engine, executing on the computer processor, and configured to: receive a plurality of well completions for the location, and compare a first well completions of the plurality of well completions to a second well completions of the plurality of well completions; and an output module stored in memory, executing on the computer processor, and configured to display the first well completion and the second well completion to a user.

### RELATED APPLICATION DATA

The current application claims the benefit of U.S. provisional application Ser. No. 61/723,560, filed on Nov. 7, 2012, titled “Method And System For Offering And Procuring Well Services”, the entire content of which is incorporated herein by reference.

### BACKGROUND

Completion services are required for most North American oil and gas wells and include, but are not limited to fracturing, perforating, completion staging, flowback etc. Successful well completion processes require a multitude of resources, including equipment, proppants, water, diesel, and others. Completion processes also have environmental implications such as engine emissions while driving or pumping, fugitive methane emissions, dust and venting of produced substances into the atmosphere during the well start up process. Services associated with completion processes such as flowback water transfer, treatment, and disposal also have a footprint, such as an environmental footprint. Some development impacts are more social in nature (traffic, noise etc) but also need to be considered during completion planning.

The full environmental profile of completion operations is so wide that challenges exist for an operator to fully assess prior to performing the operations. Currently, well services are ordered based on direct contact, such as through telephone discussions and face-to-face negotiations. This sort of contact may be unpredictable, time consuming, fail to allow for full disclosure of information, and lack transparency. Also, public misunderstanding and misconception exist about oil and gas well completion activities and the associated development profile.

### SUMMARY

In some embodiments, there is provided a method for calculating a plurality of asset key performance indicators (KPIs). The method comprises receiving a first plurality of customer reviews; calculating a first asset KPI based on the first plurality of customer reviews; displaying the first asset KPI to a user. In some embodiments, the asset KPI is one selected from a group consisting of a crew workmanship KPI and an equipment KPI. In some embodiments, the method may further comprise receiving a second plurality of customer reviews; calculating a second asset KPI based on the second plurality of customer reviews; displaying the second asset KPI to the user. In some embodiments, the method may further comprise comparing the first asset KPI to the second asset KPI; and receiving a selection by the user indicating the first asset KPI.

In some embodiments, there is provided a method for calculating a plurality of environmental profile key performance indicators (KPIs). The method comprises receiving a location data comprising a geographical location; receiving a first completion design for enabling production at the geographical location; calculating a first environmental profile KPI of the plurality of environmental profile KPIs using the first completion design and the location data; and displaying the first environmental profile KPI to a user. The method may further comprise receiving, from the user, a second completion design for enabling production at the geographical location. In some embodiment, the method may further comprise calculating a second environmental profile KPI of the plurality of environmental profile KPIs using the second completion design and the location data; and displaying the second environmental profile KPI and to the user.

In some embodiments, there is provided a system for offering well services for a location. The system comprises a computer processor and memory; an input module stored in memory, executing on the computer processor, and configured to obtain a location data item comprising a geographic location; a processing engine, executing on the computer processor, and configured to: receive a plurality of well completions for the location, and compare a first well completions of the plurality of well completions to a second well completions of the plurality of well completions; and an output module stored in memory, executing on the computer processor, and configured to display the first well completion and the second well completion to a user. The processing engine may be further configured to calculate a first environmental profile KPI for the first well completion; and the output module may be further configured to display the first environmental profile KPI to a user. In some embodiments, the processing engine is further configured to calculate a second profile KPI for the second well completion; and the output module is further configured to display the second environmental profile KPI and to the user. The processing engine may also be further configured to monitoring an implementation of the first completion design to obtain real-time data; and the output module is further configured to provide the real-time data to the user.

In some embodiments, a system for calculating a plurality of environmental profile key performance indicators (KPIs) for a location is provided. The system comprises a computer processor and memory; an input module stored in memory, executing on the computer processor, and configured to obtain a location data item comprising a geographic location; an environmental profile KPI generator stored in memory, executing on the computer processor, and configured to calculate the plurality of environmental profile KPIs for the geographic location; and an output module stored in memory, executing on the computer processor, and configured to display the plurality of environmental profile KPIs for the geographic location to a user. The output module may be configured to provide real-time data to the user. The environmental profile KPI generator may be further configured to compare a first environmental profile KPI of the plurality of environmental profile KPIs to a second environmental profile KPI of the plurality of environmental profile KPIs; and the input module is further configured to receive a selection by the user indicating the first environmental profile KPI.

In some embodiments, there is provided a non-transitory computer readable medium storing instructions for calculating a plurality of environmental profile key performance indicators (KPIs) for a location, the instructions when executed causing a processor to: receive a location data comprising a geographical location; receive a first completion design comprising a first well design for enabling production at the geographical location; calculate a first environmental profile KPI of the plurality of environmental profile KPIs using the first completion design and the location data; and display the first environmental profile KPI to a user. In some embodiments, wherein the instructions when executed further causing a processor to: calculate a second environmental profile KPI of the plurality of environmental profile KPIs using the second completion design and the location data; and display the second environmental profile KPI and to the user. In some embodiments, the instructions when executed further causing a processor to compare the first environmental profile KPI to the second environmental profile KPI and receiving a selection by the user indicating the first environmental profile KPI.

In some embodiments, there is provided a system for procuring well services for a location. The system comprises a computer processor and memory; an input module stored in memory, executing on the computer processor, and configured to obtain a location data item comprising a geographic location; a processing engine, executing on the computer processor, and configured to receive a plurality of well completions for the location, and compare a first well completions of the plurality of well completions to a second well completions of the plurality of well completions; and an output module stored in memory, executing on the computer processor, and configured to display the first well completion and the second well completion to a user.

### BRIEF DESCRIPTION OF DRAWINGS

FIGS. 1A-1B show a system in accordance with one or more aspects of the current application.

FIG. 2 shows a system in accordance with one or more aspects of the current application.

FIG. 3 shows a system in accordance with one or more aspects of the current application.

FIG. 4 shows a system in accordance with one or more aspects of the current application.

FIG. 5 shows a system in accordance with one or more aspects of the current application.

FIG. 6 shows a system in accordance with one or more aspects of the current application.

FIG. 7 shows a system in accordance with one or more aspects of the current application.

FIG. 8 shows a flow diagram in accordance with one or more aspects of the current application.

FIG. 9 shows a flow diagram in accordance with one or more aspects of the current application.

FIG. 10 shows a flow diagram in accordance with one or more aspects of the current application.

FIGS. 11A-11B show an example in accordance with one or more aspects of the current application.

FIG. 12 shows a computer system in accordance with one or more aspects of the current application.

### DETAILED DESCRIPTION

Aspects of the present disclosure are shown in the above-identified drawings and described below. In the description, like or identical reference numerals are used to identify common or similar elements. The drawings are not necessarily to scale and certain features may be shown exaggerated in scale or in schematic in the interest of clarity and conciseness. Specific aspects of the current application will now be described in detail with reference to the accompanying figures. Like elements in the various figures are denoted by like reference numerals for consistency.

In general, aspects of the current application provide a method and system for generating an index representative of the footprint (such as an environmental footprint) of a given completion design. Specifically, aspects of the current application may be used to generate an environmental profile key performance index (KPI) which may be used for comparisons between different completion designs. As referred to herein, a completion design is a term that encompasses the equipment and processes required to enable safe and efficient production from an oil or gas well. Further, a completion design may include, but is not limited to, artificial lifts, drilling, integrated projects, seismic surveying, well work over, well intervention, well construction, well cementing, well logging, well characterization, sand control, sand management, perforating, testing, flowback, well start up, well site presentation planning, reservoir development planning, enhanced oil recovery, and produced fluid treatment and management.

Organizations, particularly oil and gas operators, may use aspects of the current application to review and compare the profiles (such as an environmental footprint) of various completion designs. For example, a system implementing an aspect of the current application may enable a user to generate their own completion design or upload a completion design into the system, and compare the environmental profile of their own completion designs to those of other typical completion designs in the same location.

Aspects of the current application may use design and formulas to calculate an environmental profile and environmental profile KPIs for a completion design. Environmental profile KPIs consistent with aspects of the current application may be a single value or index intended to reflect the environmental footprint of a completion design. Aspects of the current application may also enable a user to compare the environmental profiles of various completion designs by comparing the generated environmental profile KPIs. This comparison is intended to provide users with full details, metrics, and impacts of various completion operations.

Aspects of the current application may further enable user to review the environmental profile KPIs and choose a completion design based on that user environmental goals and/or preferences. Users will be able to see the components of each completion process included in the KPIs. Such aspects may provide a user enhanced visibility on the environmental profiles in order to make informed decisions about replacing some completion services with components others that have a reduced environmental profile.

Additionally, aspects of the current application may enable a user to choose real-time job monitoring with actual environmental analysis once the job is complete. Aspects of the current application may also be used to generate environmental reports required by local, state, or federal agencies. Aspects of the current application may communicate with well site instrumentation in order to receive measurement of emissions and other environmental metrics data. Aspects of the current application also may enable users to leave feedback on the estimation provided and the services/analysis received. The feedback may then be used by subsequent users for study and reference, possibly influencing their own completion service purchasing decisions.

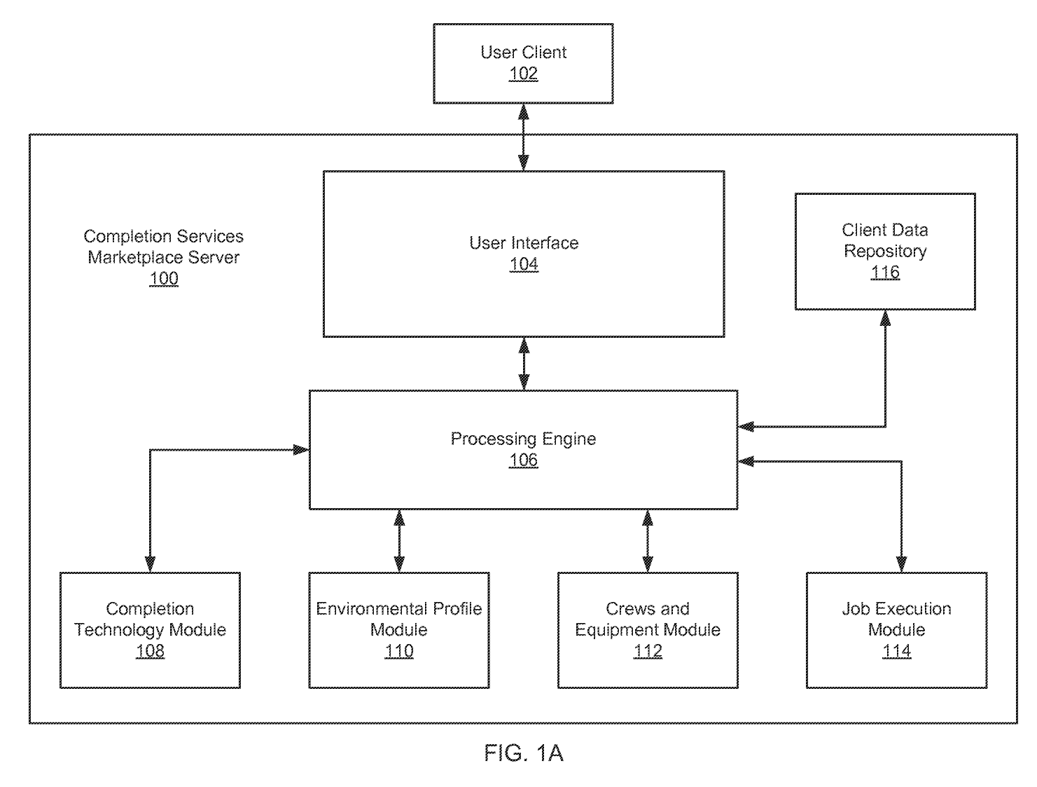

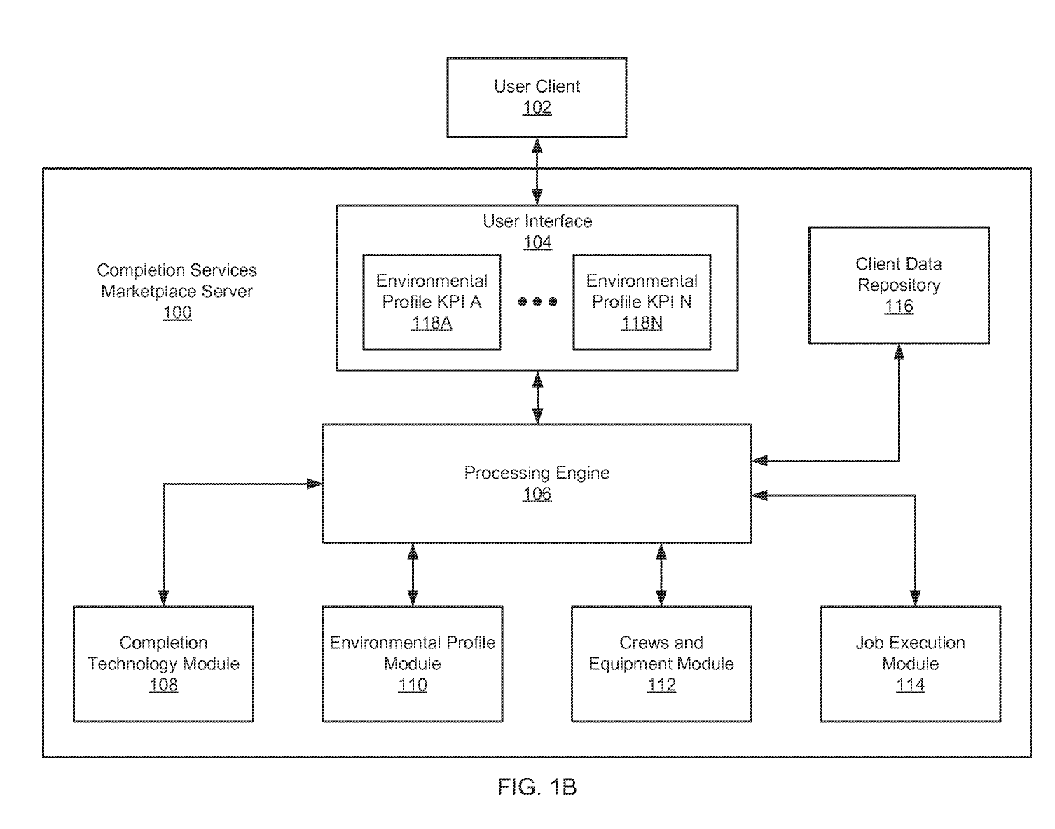

FIG. 1A shows a diagram of a system in accordance with one or more aspects of the current application. As shown in FIG. 1A, a completion services marketplace server (100) communicates with a user client (102). The completion services marketplace server (100) and the user client (102) may communicate over a computer network, satellite network, or mobile network (not shown). The completion services marketplace server (100) includes a user interface (104) and a processing engine (106), a completion technology module (108), an environmental profile module (110), a crews and equipment module (112), a job execution module (114), and a client data repository (116).

In one or more aspects of the current application, the completion services marketplace server (100) is a computer system or group of computer systems configured to execute processes and store data items related to the completion technology module (108), environmental profile module (110), crews and equipment module (112), and job execution module (114). In one aspect of the current application, the completion services marketplace server (100) includes both hardware (e.g., a processor, memory, persistent storage, network adaptor, etc.) and software (e.g., an operating system). The completion services marketplace server (100) may further include the necessary hardware and software to interface with the user client (102).

In one or more aspects of the current application, the completion marketplace server (100) is accessible via various modes of communication. For example, the completion marketplace server (100) may be accessible over a network (e.g., the Internet) or the cloud by other computer systems (e.g., desktop computers, laptop computers, tablet computers, smartphones, etc.). Further, the completion marketplace server (100) may provide different interfaces configured for the device accessing the system (e.g., a desktop browser website, a mobile browser site, etc.).

In one or more aspects of the current application, the user client (102) is a computer system or group of computer systems configured to interface with the completion services marketplace server (100). In one aspect of the current application, the user client (102) includes a web browser and network interface enabling the user client (102) to communicate with the processing engine over a network (e.g., the Internet).

In one or more aspects of the current application, the user interface (104) enables the user client (102) or other entities to access the completion services marketplace server (100). Specifically, the user interface may include a web server and web site allowing users to interact with the completion technology module (108), environmental profile module (110), crews and equipment module (112), and job execution module (114). Further, in one aspect of the current application, the user interface allows the general public to access typical completion designs, environmental profile components, explanations, and economic benefits and results of different wells. This functionality may facilitate a clear understanding of the well completion process.

In one aspect of the current application, the user interface (104) includes an input module and an output module (not shown). In one aspect of the current application, the input module is configured to enable a user to navigate between the various elements of the system and gather data from the user. In one aspect of the current application, the output module provides the system responses to user input.

Continuing with FIG. 1A, the output module may also include the functionality to generate reports required by local and federal agencies using information gathered from the different elements within and connected to the completion services marketplace server (100) in accordance with one or more aspects of the current application. For example, a local agency may require a report explaining the predicted water consumption of two planned well designs. A user may obtain such reports from the output module based on information provided to the system via the input module. The output module may also provide reports generated from information gathered from the job execution module (114), such as the actual environmental profile of a completion design monitored by the completion services marketplace server (100).

In one or more embodiments of the current application, the user interface (104) may be further configured to provide a separate level of access to the modules for use by members of the general public. For example, the user interface (104) may be configured to render a visual depiction of a well for presentation to a user via the output module. A user may have the ability to click on the rendered well picture and get details on well completion components. The user may also be presented with the potential economic impact of the well (jobs created, houses heated, cars filled, etc). The user may also be presented with graphics explaining each process in the completion design to improve the user's understanding.

In one or more aspects of the current application, the processing engine (106) is a process or group of processes configured to coordinate communication between the user interface and the completion technology module (108), environmental profile module (110), crews and equipment module (112), and job execution module (114). In one embodiment of the current application, the processing engine (106) is configured to obtain data from the user client (102) via the user interface (104), and store the data in the client data repository (116). Such data may include, but is not limited to, basic client information, type of well formation, and job dates.

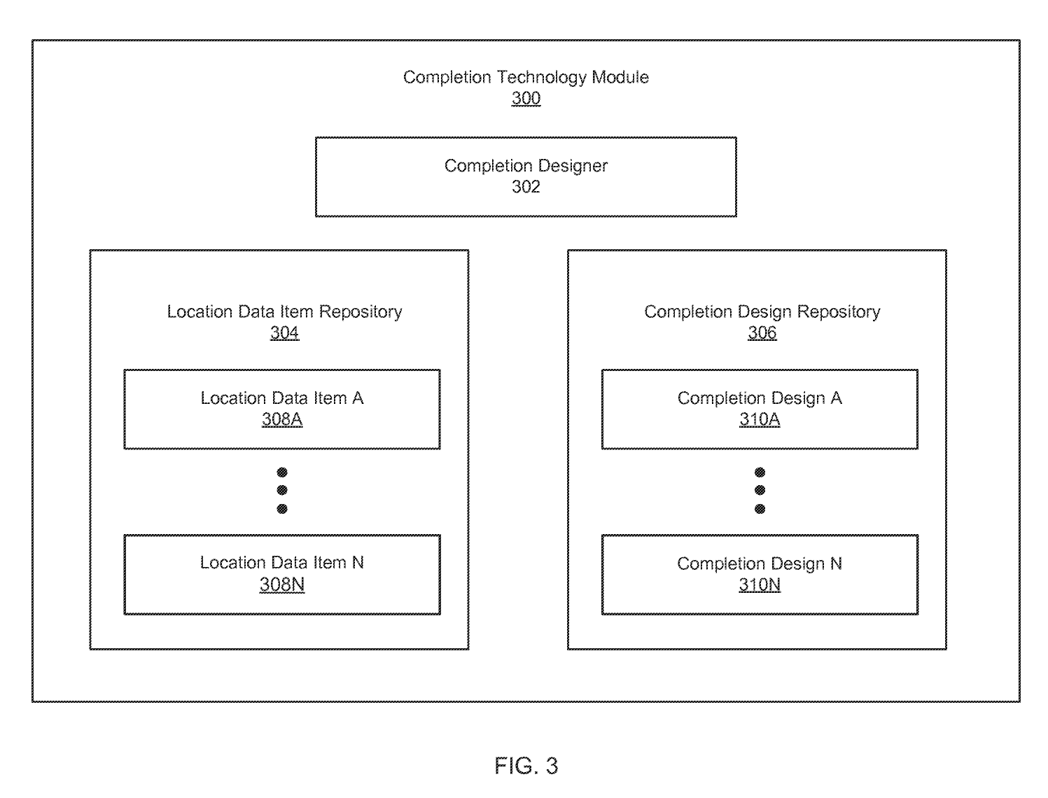

In one or more aspects of the current application, the completion technology module (108) includes functionality to obtain one or more completion designs based on input from a user client. Specifically, the completion technology module includes a completion designer and completion design repository allowing the user client (102) to either design, upload, or select a completion design to be evaluated and implemented by the environmental profile module (110), crews and equipment module (112), and job execution module (114). Further detail about the completion technology module (108) is provided in FIG. 3.

In one or more aspects of the current application, the crews and equipment module (112) includes functionality to facilitate selection of crews and equipment for executing a job using a selected well completion design. Specifically, the crews and equipment module (112) may determine the availability of crews and equipment to implement a well completion design. Further, the crews and equipment module (112) may also facilitate the selection of crews and equipment available for the job by presenting a user client (102) with customer feedback for crews and equipment, and by calculating a crew workmanship KPI and equipment KPI for the available crews and equipment. Further detail regarding the crews and equipment module (112) is provided in FIG. 5.

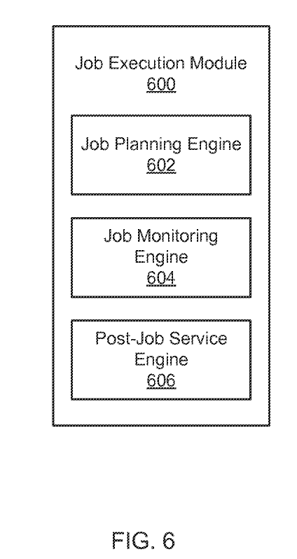

In one or more aspects of the current application, the job execution module (114) includes functionality to plan and monitor a job, as well as provide post-job services to a user client (102). Further detail regarding the job execution module (114) is provided in FIG. 6.

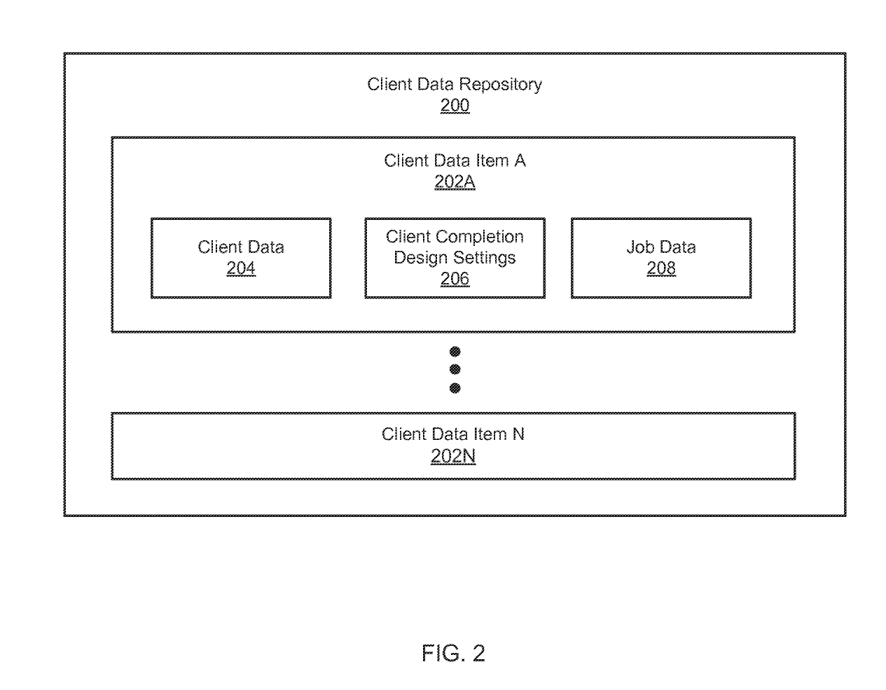

In one or more aspects of the current application, the client data repository (116) is a collection of data items used to store information specific to a user client (102). Further detail regarding the client data repository (116) is provided in FIG. 2.

Continuing with FIG. 1A, in one or more aspects of the current application, the completion services marketplace server (100) also includes functionality to interface with sources of data used to populate the repositories in the modules. Specifically, the completion services marketplace server (100) may be configured to interface with various networks and servers in order to obtain up-to-date information about each geographic location described by data items in the location data item repository, current availability and schedules for the crew and equipment schedule repository, and the latest completion technologies for completion design repository.

In one or more aspects of the current application, the data acquisition system (124) may be configured to gather data from different kinds of information sources. Such sources may include, for example, publicly available municipal websites containing local restrictions related to oil and gas production, calendaring applications made available by equipment suppliers, and environmental profile statistics generated by university researchers and hosted on a limited-access server. In one aspect of the current application, data may also be inputted directly into the repositories via the data acquisition system (124).

FIG. 1B shows a system in accordance with one or more embodiments of the invention. Specifically, the system in FIG. 1B is substantially similar to the system presented in FIG. 1A (and the named components with like reference numbers in FIG. 1B include equivalent functionality as those described in relation to FIG. 1 A). FIG. 1B further depicts the user interface (104) as configured to present generated environmental profile KPIs (environmental profile KPI A (118A), environmental profile KPI N (118N)) to the user client (102). Specifically, the output module of the user interface (104) may be configured to present the generated environmental profile KPIs (environmental profile KPI A (118A), environmental profile KPI N (118N)) to the user client (102).

In one or more aspects of the current application, the output module is configured to allow a user to compare different generated environmental profile KPI (environmental profile KPI A (118A), environmental profile KPI N (118N)) to one another to facilitate a choice or more environmentally friendly completion designs. Further, users may be able to compare and contrast different factors gathered from the different modules in order to select a completion based on availability, price, risk, and environmental KPIs (environmental profile KPI A (118A), environmental profile KPI N (118N)). For example, a user may compare the overall environmental profile KPI (environmental profile KPI A (118A), environmental profile KPI N (118N)) for two different completion designs, and then compare specific metrics (such as physical well footprint) within each environmental profile KPI (environmental profile KPI A (118A), environmental profile KPI N (118N)).

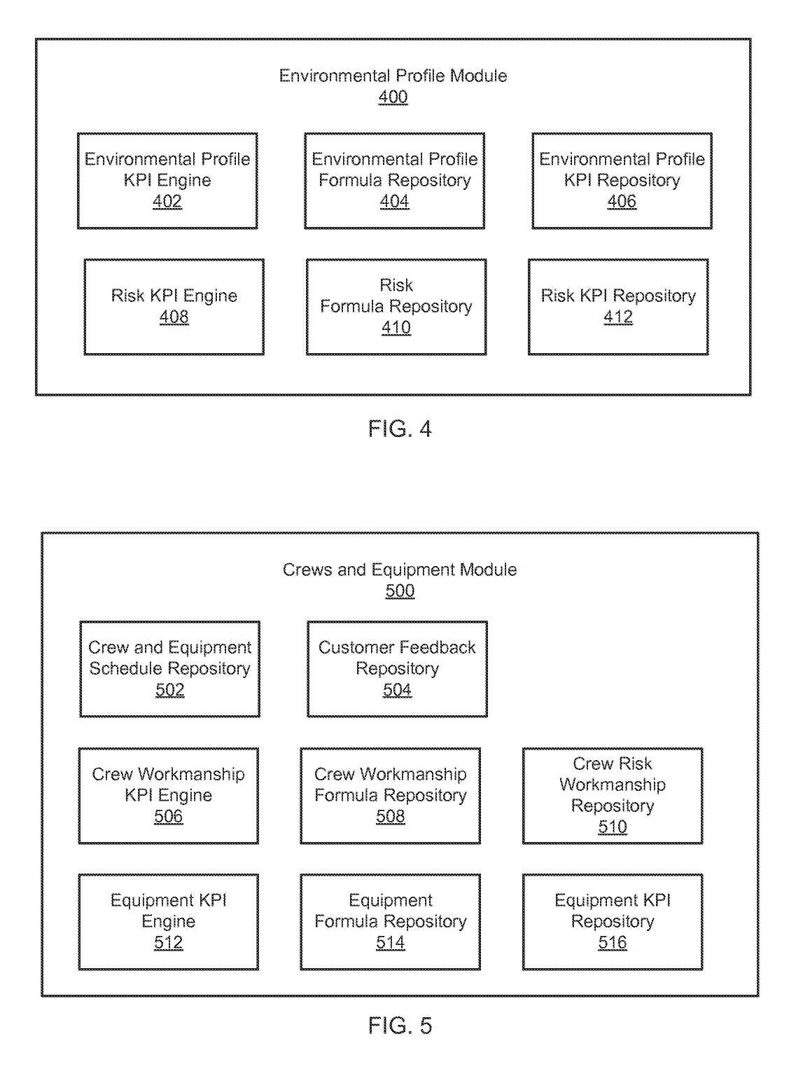

In one or more aspects of the current application, the environmental profile module (110) includes functionality to calculate environmental profile KPIs (environmental profile KPI A (118A), environmental profile KPI N (118N)) and risk KPIs (not shown) based on a completion design. Specifically, the processing engine (106) obtains a set of completion designs from the user interface (104) and the completion technology module (108), and provides the completion designs to the environmental profile module (110) for analysis and determination of the environmental profile KPIs (environmental profile KPI A (118A), environmental profile KPI N (118N)) and risk KPIs (not shown). Further detail regarding the environmental profile module (110) is provided in FIG. 4.

FIG. 2 shows a client data repository in accordance with one or more embodiments of the current application. As shown in FIG. 2, the client data repository (116) includes multiple client data items (client data item A (202A), client data item N (202N)). Each client data item (client data item A (202A), client data item N (202N)) includes client data (204), client completion design settings (206), and job data (208).

In one or more embodiments of the current application, the client data includes basic information about a client. Such information may include, for example, name, location, username, password, and contact information. In one or more aspects of the current application, the client data (204) may also store data items expressing how different metrics are to be considered by the environmental profile module. Specifically, the client data (204) may be used by the environmental profile module to prioritize or favor certain factors or metrics over others. For example, a user may indicate a maximum emissions that a well completion design should have. As a result, the environmental profile module may reorder the completion designs presented to that user based on the emissions setting.

In one or more embodiments of the current application, the client completion design settings (206) include information about completion designs uploaded by a user client or generated by the user client via a completion designer. Specifically, the client completion design settings (206) are data items describing the elements of the completion design selected by a user. Specifically, the client completion design settings (206) may include data items which represent the specific elements of a user-designed completion design. Such elements may include, for example, a casing program and a cement program.

In one or more embodiments of the current application, the job data (208) includes data items used by the processing engine to identify a job associated with a user client and tracked by the job execution module. Job data (208) may also store information about a job or jobs gathered periodically by the job execution module. Such job data (208) may include, but is not limited to, recent output rate, time, surface pressure, etc. Job data (208) may be presented to a user client when that user client logs into the system. Job data (208) may also include environmental metric measurements such as actual miles driven, engine emission rates, noise levels, energy consumed, dust levels, water consumption rates, and cumulative measurements of multiple metrics.

FIG. 3 shows a completion technology module in accordance with one or more embodiments of the current application. As shown in FIG. 3, the completion technology module (300) includes a completion designer (302), a location data item repository (304), and a completion design repository (306). In one or more aspects of the current application, the completion designer (302) is a tool for designing a completion design. Specifically, the completion designer (302) includes functionality to enable a user to input data about a completion design (oil or gas, type of geology, vertical, or horizontal, etc.) and produce a completion design matching the user's input. In one or more aspects of the current application, the completion designer (302) also includes functionality to properly pair certain features based on data entered into the system. As another example, the absence of a local water source will require procurement and transportation of water to the well site. Once the design process is finished, the user may be provided with a summary of the necessary resources and environmental footprint of the well the user designed.

Continuing with FIG. 3, the completion designer (302) may also include functionality to produce a list of completion technologies appropriate for a selected formation in accordance with one or more aspects of the current application. This list may include technology descriptions and components, completion technology providers, completion job risk KPIs based on chemicals and proppants used, prices, and previous customer feedback. If estimated production is provided, the completion designer (302) may also calculate an estimated net present value for each design. The completion designer (302) may also enable a user to select a preferred design. In one or more aspects of the current application, the completion designer (302) may also show statistics on typical completion designs. Further, the completion designer (302) may also enable a user to upload their own completion data via the user interface.

Continuing with the description of FIG. 3, the location data item repository (304) includes a number of location data items (location data item A (308A), location data item N (308N)). Each location data item (location data item A (308A), location data item N (308N)) may include information such as a surface location data item, a subterranean location data item, and a regulatory data item. In one aspect of the current application, each location data item (location data item A (308A), location data item N (308N)) is associated with a geographic location. In one aspect of the current application, the geographic location is a broadly described region, such as a country, continent, or territory. In one aspect of the current application, the geographic location is a narrower location, such as a state, city, town, or specific geographic coordinates.

In one aspect of the current application, each location data item (location data item A (308A), location data item N (308N)) includes information regarding the surface conditions of a geographic location. Such conditions may include physical terrain, flora and fauna, wildlife, climate, and accessibility by humans. In one aspect of the current application, each location data item (location data item A (308A), location data item N (308N)) includes information regarding the subterranean conditions of the geographic location. Such conditions may include the geology of the location, subterranean water sources, and the existence of other types of minerals that may impact the well completion. In one aspect of the current application, each location data item (location data item A (308A), location data item N (308N)) includes information related to any pertinent rule and regulations that apply in the geographic location. Such rules and regulations may include federal statutes and local operating licensing procedures. In one aspect of the current application, the location data item repository (304) includes other elements not listed above.

Continuing with the description of FIG. 3, the completion design repository (306) is a store of data items containing information about various completion designs. Specifically, the completion design repository (306) may include data related to the processes, structures, and equipment necessary for a given completion design. In one or more embodiments of the invention, the completion design repository (306) includes a number of completion designs (completion design A (310A), completion design N (310N)). Each completion design (completion design A (310A), completion design N (310N)) may include a well design data item, an equipment data item, and a completion process data item.

In one aspect of the current application, each completion design (completion design A (310A), completion design N (310N)) includes information about the design of a well completion. Each completion design (completion design A (310A), completion design N (310N)) may include information such as physical dimensions, construction materials, and the different elements that make up the completion design. In one aspect of the current application, each completion design (completion design A (310A), completion design N (310N)) may also include information about the equipment necessary to build and operate the completion design. Such equipment may include surface/downhole equipment and operating resources necessary for the completion design. In one aspect of the current application, each completion design (completion design A (310A), completion design N (310N)) may further include information about the procedures and timelines for constructing and operating the completion design. Such procedures and timelines may include typical well construction times, compatibility with different types of geology, resources necessary to build and maintain the completion design, statistical data on historical well completions, such as typical completion systems used, typical type of proppant, and flowback water profile. In one aspect of the current application, the completion design repository (306) includes other elements not listed above. Further, each completion design (completion design A (310A), completion design N (310N)) may include, but is not limited to, artificial lifts, drilling, integrated projects, seismic surveying, well work over, well intervention, well construction, well cementing, well logging, well characterization, sand control, sand management, perforating, testing, flowback, well start up, well site presentation planning, reservoir development planning, enhanced oil recovery, and produced fluid treatment and management.

FIG. 4 shows an environmental profile module in accordance with one or more embodiments of the current application. As shown in FIG. 4, the environmental profile module (400) includes an environmental profile KPI engine (402), an environmental profile formula repository (404), an environmental profile KPI repository (406), a risk KPI engine (408), a risk formula repository (410), and a risk KPI repository (412).

In one or more aspects of the current application, the environmental profile KPI Engine (402) includes functionality to generate an environmental profile KPI for a completion design. In one aspect of the current application, the environmental profile KPI will be calculated based on formula that takes into account the environmental profile for each element of the completion design and importance/weight of each factor set in the client data.

In one or more aspects of the current application, the environmental profile formula repository (404) is a store of formulas used to calculate the resources needed and environmental profile of each process associated with a completion design. In one aspect of the current application, formulas stored in the environmental profile formula repository (404) may account for multiple factors affecting the environmental profile of each element in a completion design. Such factors may include, for example, the availability of a water source and number of staff necessary. Each environmental profile KPI calculated by the environmental profile KPI Engine (402) may be stored in the environmental profile KPI repository (406)

In one or more aspects of the current application, the risk KPI Engine (408) includes functionality to generate a risk KPI for a completion design. In one aspect of the current application, the risk KPI will be calculated based on formula that takes into account the dangers to the environment and crew for each element of the completion design and importance/weight of each factor set in the client data.

In one or more aspects of the current application, the risk formula repository (410) is a store of formulas used to calculate the risks to the environment and crew of each process associated with a completion design. In one aspect of the current application, formulas stored in the risk formula repository (410) may account for multiple factors affecting the risks associated with each element in a completion design. Such factors may include, for example, the amount of hazardous chemicals used or produced by a completion well, the level of difficulty in handling certain equipment, as well as the accident rate associated with the equipment, and proximity to local populations. Each risk KPI calculated by the risk KPI Engine (408) may be stored in the risk KPI repository (412)

FIG. 5 shows a crews and equipment module in accordance with one or more embodiments of the current application. As shown in FIG. 5, the crew and equipment module (500) includes a crew and equipment schedule repository (502), a customer feedback repository (504), a crew workmanship KPI engine (506), a crew workmanship formula repository (508), a crew workmanship KPI repository (510), an equipment KPI engine (512), an equipment formula repository (514), and an equipment KPI repository (516).

In one or more aspects of the current application, the crew and equipment schedule repository (502) is a store of data items describing the availability of personal for staffing a well completion. In one aspect of the current application, the crew and equipment schedule repository (502) will include functionality to provide information about equipment required for a selected completion design. Further, in one aspect of the current application, the crew and equipment schedule repository (502) also includes the functionality to provide information about companies that can provide crews and equipment, the companies that have the equipment available for the selected days, and cost estimates.

In one aspect of the current application, the crew and equipment schedule repository (502) includes the necessary information to populate an availability calendar for all providers. Further, crew and equipment schedule repository (502) may also include functionality to return a list of available vendors in response to a search for capabilities (equipment, special requests, days required).

In one or more aspects of the current application, the customer feedback repository (504) stores customer reviews and ratings of the crews and equipment available in the crew and equipment schedule repository (502). The customer feedback repository (504) may be used to facilitate a selection between different crews and equipment available for a job. Further, the customer feedback repository (504) may be used by the crew workmanship KPI engine (506) and the equipment KPI engine (512) in calculating the KPIs for different crews and equipment, further aiding in the selection between different crews and equipment. As used herein, the term asset KPI refers generally to KPIs related to crews, equipment and/or other assets used by a company. The term asset KPI also generally includes crew workmanship KPIs and equipment KPIs.

In one or more aspects of the current application, the crew workmanship KPI engine (408) includes functionality to generate a crew workmanship KPI for a given crew. In one aspect of the current application, the crew workmanship KPI will be calculated based on formula that takes into account various metrics associated with a certain crew and the importance/weight of each factor set in the client data.

In one or more aspects of the current application, the crew workmanship formula repository (508) is a store of formulas used to calculate the crew workmanship of a crew selected for work on a completion design. In one aspect of the current application, formulas stored in the crew workmanship formula repository (508) may account for multiple factors affecting the crew workmanship. Such factors may include, for example, level of crew experience, prior service quality issues, and customer feedback for a crew. Each crew workmanship KPI calculated by the crew workmanship KPI engine (506) may be stored in the crew workmanship KPI repository (510)

In one or more aspects of the current application, the equipment KPI engine (512) includes functionality to generate an equipment KPI for different equipment necessary for a completion design. In one aspect of the current application, the equipment KPI will be calculated based on formula that takes into account various metrics associated with a set of equipment and the importance/weight of each factor set in the client data.

In one or more aspects of the current application, the equipment formula repository (514) is a store of formulas used to calculate the equipment KPIs for different sets of equipment necessary for a completion design. In one aspect of the current application, formulas stored in the equipment formula repository (410) may account for multiple factors affecting the equipment. Such factors may include, for example, the age of the equipment, type of technology implemented by the equipment, and customer feedback of the equipment. Each equipment KPI calculated by the equipment KPI Engine (512) may be stored in the equipment KPI repository (516)

FIG. 6 shows a job execution module in accordance with one or more embodiments of the current application. As show in FIG. 6, the job execution module (600) includes a job planning module (602), a job monitoring engine (604), and a post-job service engine (606).

In one aspect of the current application, the job planning module (602) includes functionality to plan a job using an electronic check list. The check list may include schedules for the various entities involved, and may provide this data in real time. For example, once equipment has been dispatched to a job location, the job planning module (602) will monitor the equipment location via real-time equipment locators or GPS systems.

In one or more aspects of the current application, the job monitoring engine (604) is a module configured to capture real-time data from a well and display that data via the user interface. In one aspect of the current application, the job monitoring engine (604) interacts with a well's data acquisition system and data transmitters to gather the monitored data. In one aspect of the current application, the job monitoring engine (604) may further be configured to provide analysis and interpretation of the gathered well data. For example, the job monitor may include functionality to alert a user if one metric (such as water consumption) exceeds a predetermined threshold.

In one aspect of the current application, the job monitoring engine (604) is configured to provide monitoring data to environmental profile module in order for the environmental profile module to refine one or more formulas in the formula repositories. Specifically, in one aspect of the current application, if the environmental profile KPI engine detects that certain predictions within the generated environmental KPIs for a completion design deviate significantly from the data gathered from the job monitor for that completion design, then the environmental profile KPI engine may then adjust one or more formulas in the environmental profile formula repository to account for the difference.

In one aspect of the current application, the post-job service engine (606) includes functionality to address administrative tasks after job completion, such as web based customer job acceptance, invoice, invoice status, payment receipt and payment status. The post-job service engine (606) may also allow customer feedback on the job completed to be stored in the customer feedback repository.

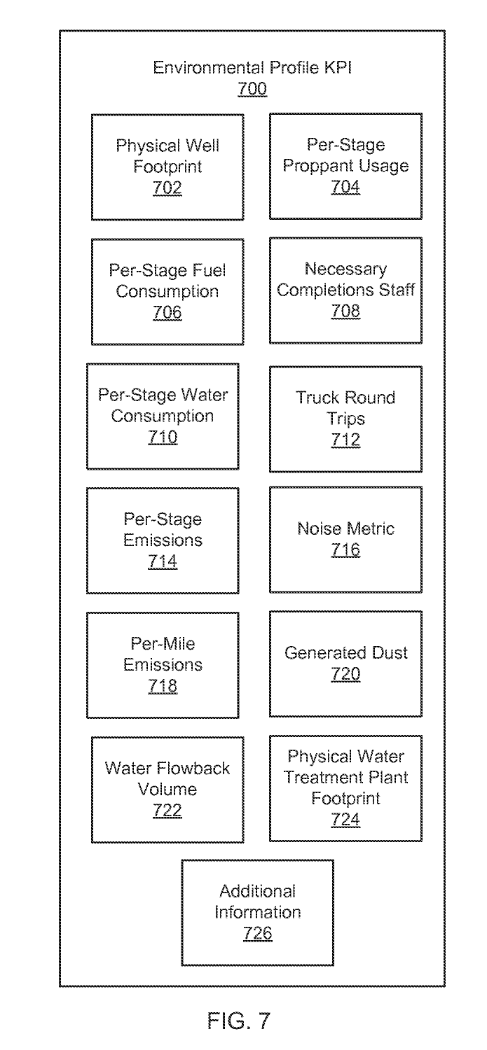

FIG. 7 shows a diagram of a system in accordance with one or more aspects of the current application. As shown in FIG. 7, the environmental profile KPI (700) includes a number of metrics about a completion design. Specifically, as shown in FIG. 7, the environmental profile KPI (700) includes a physical well footprint (702), per-stage proppant usage (704), per-stage fuel consumption (706), necessary completion staff (708), per-stage water consumption (710), truck round trips (712), per-stage emissions (714), a noise metric (716), per-mile emissions (718), generated dust (720), water flowback volume (722), and physical water treatment plant footprint (724). The environmental profile KPI (700) may also include additional information (726) not listed above. Such additional information (726) may include, but is not limited to, artificial lifts, drilling, integrated projects, seismic surveying, well work over, well intervention, well construction, well cementing, well logging, well characterization, sand control, sand management, perforating, testing, flowback, well start up, well site presentation planning, reservoir development planning, enhanced oil recovery, and produced fluid treatment and management.

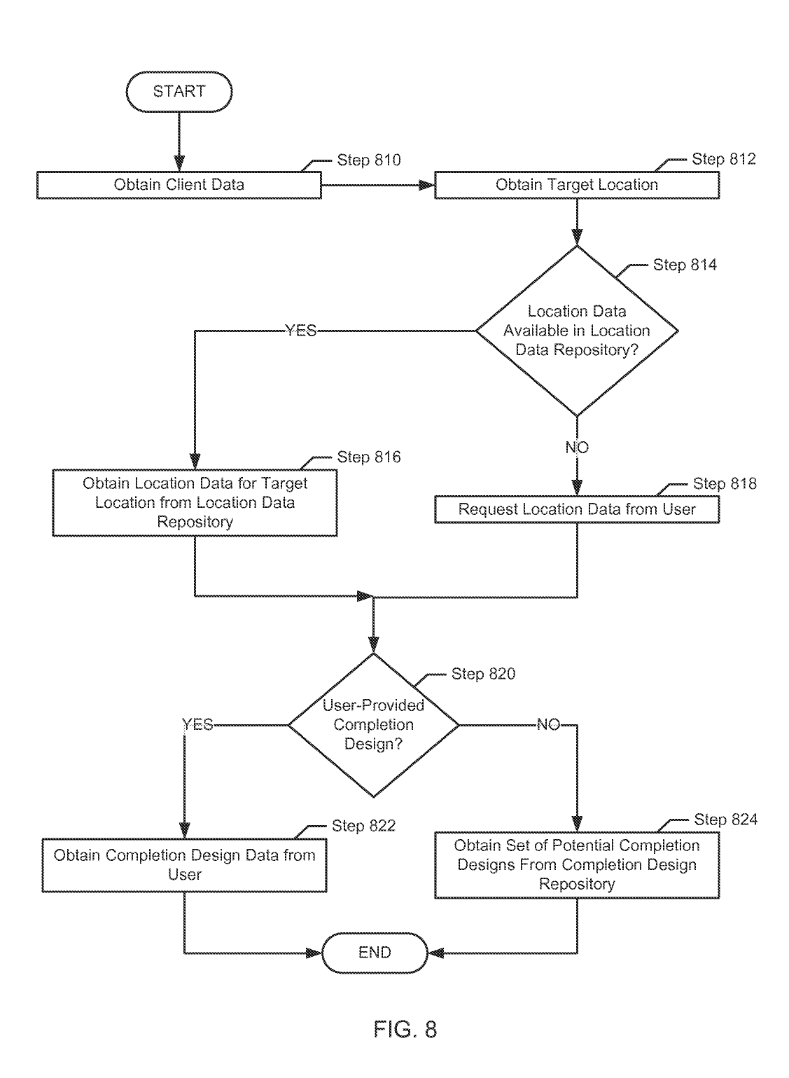

FIG. 8 shows a flowchart for obtaining client information in accordance with one or more aspects of the current application. While the various steps in these flowcharts are presented and described sequentially, one of ordinary skill will appreciate that some or all of the steps may be executed in different orders, may be combined or omitted, and some or all of the steps may be executed in parallel.

In Step 810, the processing engine obtains client data from a user client. In one embodiment of the current application, the client data includes dates for a well completion. In Step 812, the processing engine obtains a target location from a user client. In one embodiment of the current application, the target location is a well site at which the user desires to implement the well completion. In Step 814, the processing engine determines whether there is a location data item corresponding to the received target location in the location data repository. If there is a location data item available in the location data repository then in Step 816, the processing engine obtains the location data for the target location from the location data repository.

If the processing engine determines that no location data is available in the location data repository, then in Step 818, the processing engine requests the location data from the user. In Step 820, the processing engine determines whether the user has provided a completion design. In one aspect of the current application, the user may provide a completion design by uploading the completion design into the processing engine via the user interface. In one aspect of the current application, the user may provide a completion design by designing the completion design in the completion designer within the processing engine. If the user provides a completion design, then in Step 822, the processing engine obtains the completion design from the user.

If in Step 820, the user has not provided a completion design, then in Step 824, the processing engine obtains a set of potential completion designs from the completion design repository. In one aspect of the current application, the set of potential completion designs is obtained using user factor settings obtained from the user.

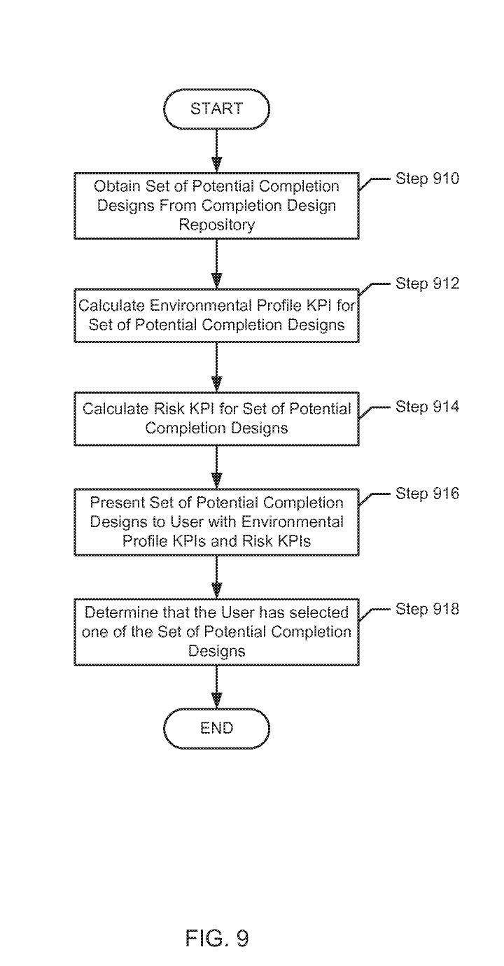

FIG. 9 shows a flowchart for providing a comparison between different completion designs to a user client in accordance with one aspect of the current application. While the various steps in these flowcharts are presented and described sequentially, one of ordinary skill will appreciate that some or all of the steps may be executed in different orders, may be combined or omitted, and some or all of the steps may be executed in parallel.

In Step 910, the processing engine obtains a set of potential completion designs from the completion design repository. In one embodiment of the current application, the processing engine obtains alternative completion designs appropriate for the location provided by the user. In Step 912, the processing engine calculates the environmental profile KPIs for a set of potential completion designs. In one embodiment of the current application, the environmental profile KPIs are numerical representations of the overall profile of a completion design. In one embodiment of the current application, the environmental profile KPIs are generated to enable a direct comparison between two completion designs based on the environmental profile of each completion design. In Step 914, the processing engine calculates the risk KPIs for a set of potential completion designs. In one embodiment of the current application, the risk KPIs are a numerical indicator of the risks associated with each completion design. In Step 916, the processing engine presents the set of potential completion designs to a user with the environmental profile KPIs and the risk KPIs. In Step 918, the processing engine determines that the user has selected one of the set of potential completion designs based on the environmental profile KPI and the risk KPI.

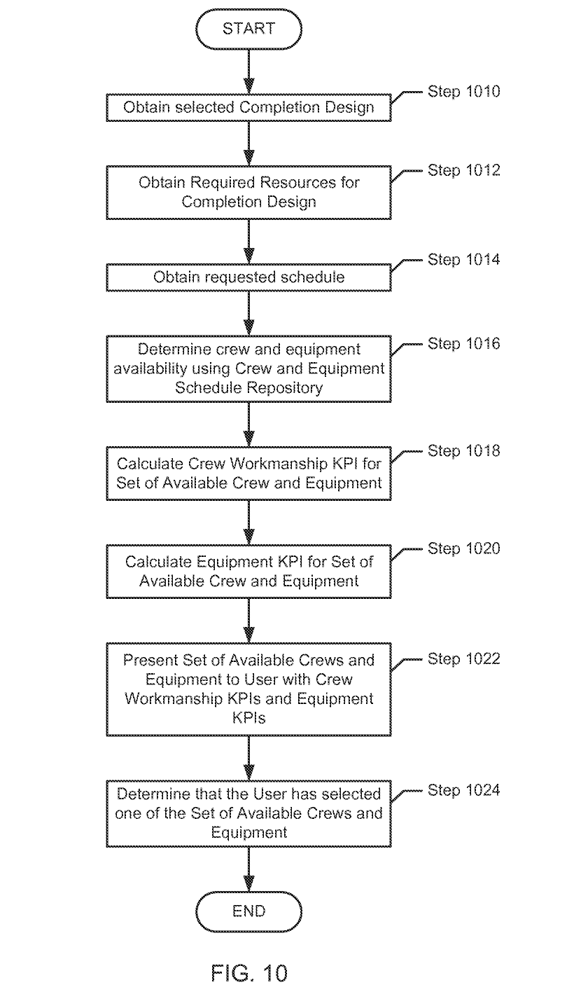

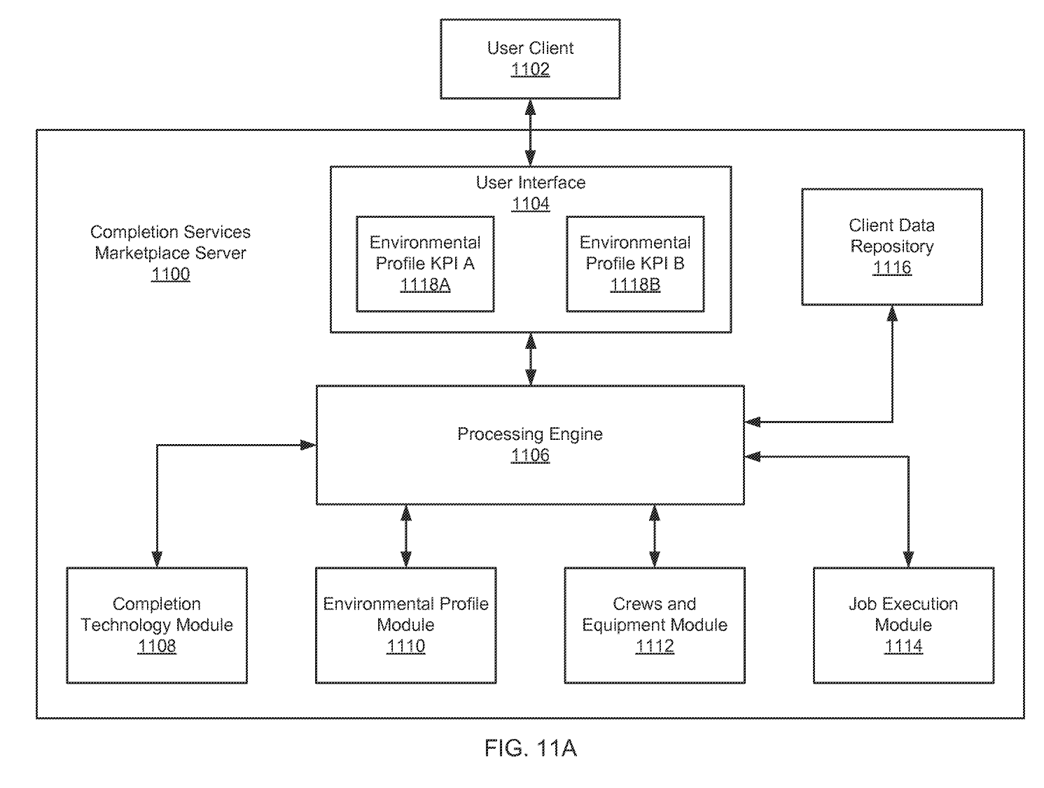

FIG. 10 shows a flowchart for providing a comparison between different crews and equipment to a user client in accordance with one aspect of the current application. While the various steps in these flowcharts are presented and described sequentially, one of ordinary skill will appreciate that some or all of the steps may be executed in different orders, may be combined or omitted, and some or all of the steps may be executed in parallel.

In Step 1010, the processing engine obtains the selected completion design. In Step 1012, the processing engine obtains the required resources for the completion design. In one embodiment of the current application, the required resources are stored in the completion designs repository. In Step 1014, the processing engine obtains the requested schedule. In one embodiment of the current application, the schedule is derived from information provided by the user and stored in a client data repository. In Step 1016, the processing engine determines the crew and equipment availability using the crew and equipment schedule repository. In one embodiment of the current application, the crew and equipment schedule repository is updated periodically from schedule resources for each set of crews and equipment. In Step 1018, the processing engine calculates the crew workmanship KPI for the set of available crews and equipment. In one embodiment of the current application, the crew workmanship KPIs are a numerical indicator of the professionalism and abilities associated with each available crew. In Step 1020, the processing engine calculates the equipment KPI's for the set of available crews and equipment. In one embodiment of the current application, the equipment KPIs are a numerical indicator of the quality of each available set of equipment. As discussed above, crew workmanship KPIs and equipment KPIs may be referred to generally as asset KPIs. In one embodiment of the invention, Steps 1018 and 1020 may be combined such that the processing engine calculates the asset KPIs for the sets of available crews and equipment.

In Step 1022, the processing engine presents the set of available crews and equipment to the user with the crew workmanship KPIs and equipment KPIs. In Step 1024, the processing engine determines that the user has selected one of the set of available crews and equipment.

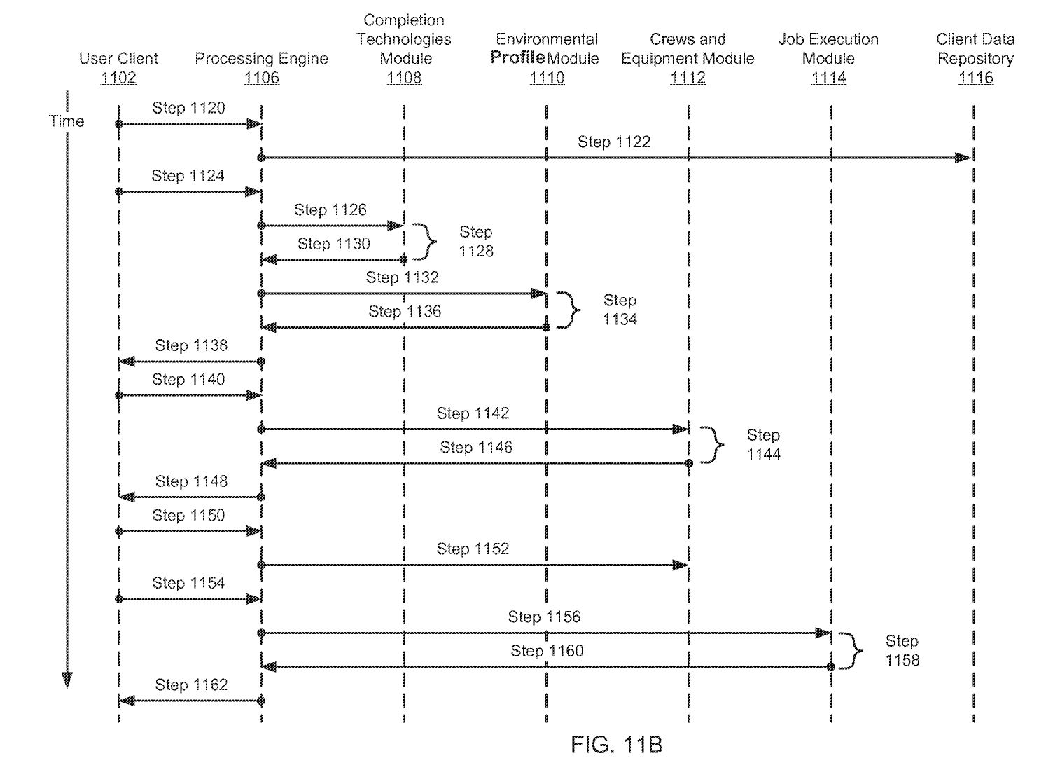

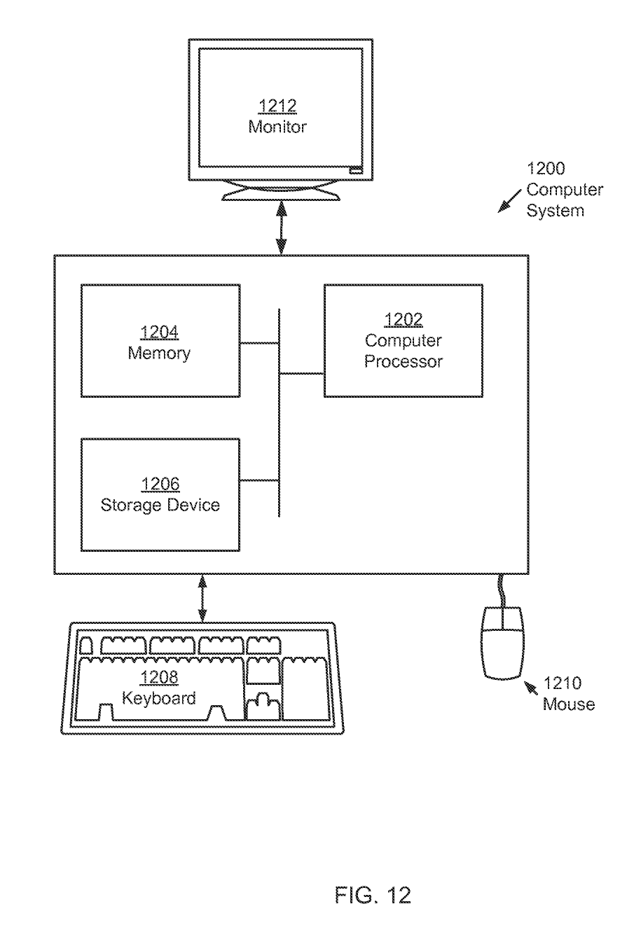

FIGS. 11A and 11B show an example system and timeline in accordance with one or more aspects of the current application. As shown in FIG. 11A the exemplary system includes a completion services marketplace (1100) communicatively connected to a user client (1102). The completion services marketplace server (1100) includes a user interface (1104) and a processing engine (1106), a completion technology module (1108), an environmental profile module (1110), a crews and equipment module (1112), a job execution module (1114), and a client data repository (1116). The user interface (1104) is configured to present generated environmental profile KPIs (environmental profile KPI A (118A), environmental profile KPI B (118B)) to the user client (1102).

For the purposes of this example, assume that a user wants to build a well with minimal per-stage emissions. At Step 1120, the user using the user client (1102) provides client data to the processing engine (1106). At Step 1122, the processing engine (1106) stores the client data in the client data repository (1116). This client data includes the user's preference for a completion design with minimal per-stage emissions, and the dates the user would like to implement the completion design. This client data further includes the location of the well. At Step 1124, the user (via the user client (1102)) uploads a file containing a completion design to the processing engine (1106).

At Step 1126, the processing engine (1106) sends the uploaded completion design to the completion technologies module (1108). Also at Step 1126, the processing engine (1106) requests similar completion designs appropriate for the user's location. At Step 1128, the completion technologies module (1108) stores the uploaded completion design in the completion design repository. Also at Step 1128, the completion technologies module (1108) searches for other completion designs appropriate for the user's location. At Step 1130, the completion technologies module (1108) provides an alternative completion design to the processing engine (1106).

At Step 1132, the processing engine (1106) sends the uploaded completion design and the alternative completion design to the environmental profile module (1110). At 1134, the environmental profile module (1110) calculates the environmental profile KPI for the uploaded completion design (environmental profile KPI A (1118A)) and the alternative completion design (environmental profile KPI B (1118B)). For the purposes of this example, assume that the uploaded completion design has a slightly higher environmental profile KPI (environmental profile KPI B (1118B)) (indicating a smaller environmental footprint) then the alternative completion design. Further, assume that the alternative completion design has a slightly lower per-stage emissions then the uploaded completion design. Also at Step 1134, the environmental profile module (1110) calculates the risk KPI for the uploaded completion design and the alternative completion design. Assume for the purposes of this example that the risk KPI for the uploaded completion design and the alternative completion design are the same.

At Step 1136, the environmental profile module (1110) provides the environmental profile KPIs and the risk KPIs to the processing engine (1106). At step 1138, the processing engine (1106) presents the environmental profile KPIs and the risk KPIs for the uploaded completion design and the alternative completion design to the user using the user client (1102). Because the user has indicated a preference for low per-stage emissions, the results list will be sorted according to the lowest her stage emissions completion design (the alternative completion design will be displayed first).

At Step 1140, the user client (1102) selects the alternative completion design. At Step 1142, the processing engine (1106) sends the alternative completion design to the crews and equipment module (1112). At Step 1144, the crews and equipment module (1112) determines the crews and equipment available to implement the completion design during the dates desired by the user. Also at Step 1144, the crews and equipment module (1112) calculates the crew workmanship KPIs and the equipment KPIs for each available set of crews and equipment. Each of these KPIs is based partially on the customer feedback stored in the customer feedback repository.

At Step 1146, the crews and equipment module (1112) sends the list of available crews and equipment along with the crew workman KPIs and the equipment KPIs to the processing engine (1106). At Step 1148, the processing engine (1106) presents the available crews and equipment along with the crew workman KPIs and equipment KPIs to the user using the user client (1102). At step 1150, the user using the user client (1102) selects the crew and equipment with the highest crew workman KPI and equipment KPIs to implement the completion design. At step 1154, the processing engine (1106) initializes the execution of the job using the alternative completion design via the crews and equipment module (1112).

At Step 1154, the user using the user client (1102) requests information from the processing engine (1106) regarding the currently underway well completion using the alternative completion design. At Step 1156, the processing engine (1106) requests the information from the job execution module (1114). At Step 1158, the the job monitoring module inside the job execution module (1114) obtains the information from a data acquisition system at the well site. At Step 1160, the information is forwarded to the processing engine (1106). At Step 1162, the job monitoring information is presented to the user via the user client (1102).

Generally, embodiments of the invention may be implemented as a single website or portal where a client can order both products (technology, materials, etc.) and services (crews, equipment, etc.). Specifically, clients may use embodiments of the invention during the planning stages of a well, in which a well completion may be selected and the elements necessary to schedule and initiate work on the well may be ordered.

Such a website or portal may be part of a cloud computing infrastructure configured to provide the products and services. Specifically, a website or portal implementing aspects of the current application may be accessible by different types of client devices, such as mobile phones, tablets, personal computer systems, and portable computer systems.

Further, embodiments of the invention may be implemented in a way as to allow a client to monitor a job through the website or portal, once ordering has been completed. Specifically, a client may return to such embodiments in order to obtain real-time data gathered from the well as work on the well progresses.

Embodiments of the invention may be further implemented to allow a client to provide feedback on the products and services ordered. Specifically, clients may express their opinion on the services and products obtained, and that feedback may then be provided to future clients interested in the same or similar products or services.

Aspects of the system and method of offering and procuring well services involving generating one or more environmental profile key performance indicator (KPIs) may be implemented on virtually any type of computer regardless of the platform being used. For example, as shown in FIG. 8, a computer system (1200) includes one or more computer processor(s) (1202) such as a central processing unit (CPU) or other hardware processor(s), associated memory (1204) (e.g., random access memory (RAM), cache memory, flash memory, etc.), a storage device (1206) (e.g., a hard disk, an optical drive such as a compact disk drive or digital video disk (DVD) drive, a flash memory stick, etc.), and numerous other elements and functionalities typical of today's computers (not shown). In one or more aspects of the current application, the computer processor (1202) is hardware. For example, the computer processor may be an integrated circuit. The computer system (1200) may also include input means, such as a keyboard (1208), a mouse (1210), or a microphone (not shown). Further, the computer system (1200) may include output means, such as a monitor (1212) (e.g., a liquid crystal display (LCD), a plasma display, or cathode ray tube (CRT) monitor). The computer system (1200) may be connected to a network (1214) (e.g., a local area network (LAN), a wide area network (WAN) such as the Internet, a mobile communications network, or any other type of network) via a network interface connection (not shown). Those skilled in the art will appreciate that many different types of computer systems exist, and the aforementioned input and output means may take other forms. Generally speaking, the computer system (1200) includes at least the minimal processing, input, and/or output means necessary to practice aspects of the current application.

Further, those skilled in the art will appreciate that one or more elements of the aforementioned computer system (1200) may be located at a remote location and connected to the other elements over a network. Further, aspects of the current application may be implemented on a distributed system having a plurality of nodes, where each portion of the current application (e.g., user agreement information, product use agreement pre-recordings, application store, product use agreement application, etc.) may be located on a different node within the distributed system. In one aspect of the current application, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform aspects of the current application may be stored, temporarily or permanently, on a non-transitory computer readable storage medium, such as a compact disc (CD), a diskette, a tape, memory, or any other computer readable storage device.

While the method and system for offering and procuring well services has been described with respect to a limited number of aspects, those skilled in the art, having benefit of this disclosure, will appreciate that other aspects can be devised which do not depart from the scope of the method and system for offering and procuring well services as disclosed herein. Accordingly, the scope of the current application should be limited only by the attached claims.

What is claimed is:

1. A method for calculating a plurality of asset key performance indicators (KPIs) comprising:
receiving a first plurality of customer reviews;
calculating a first asset KPI based on the first plurality of customer reviews;
displaying the first asset KPI to a user.

2. The method of claim 1, wherein the asset KPI is one selected from a group consisting of a crew workmanship KPI and an equipment KPI.

3. The method of claim 1, further comprising:
receiving a second plurality of customer reviews;
calculating a second asset KPI based on the second plurality of customer reviews;
displaying the second asset KPI to the user.

4. The method of claim 3, further comprising:
comparing the first asset KPI to the second asset KPI; and
receiving a selection by the user indicating the first asset KPI.

5. A method for calculating a plurality of environmental profile key performance indicators (KPIs) comprising:
receiving a location data comprising a geographical location;
receiving a first completion design for enabling production at the geographical location;
calculating a first environmental profile KPI of the plurality of environmental profile KPIs using the first completion design and the location data; and
displaying the first environmental profile KPI to a user.

6. The method of claim 5, further comprising:
receiving, from the user, a second completion design for enabling production at the geographical location.

7. The method of claim 6, further comprising:
calculating a second environmental profile KPI of the plurality of environmental profile KPIs using the second completion design and the location data; and
displaying the second environmental profile KPI and to the user.

8. The method of claim 7, further comprising:
comparing the first environmental profile KPI to the second environmental profile KPI; and
receiving a selection by the user indicating the first environmental profile KPI.

9. The method of claim 5, further comprising:
monitoring an implementation of the first completion design to obtain real-time data; and
providing the real-time data to the user.

10. A system for offering well services for a location comprising:
a computer processor and memory;
an input module stored in memory, executing on the computer processor, and configured to obtain a location data item comprising a geographic location;
a processing engine, executing on the computer processor, and configured to:
receive a plurality of well completions for the location, and
compare a first well completions of the plurality of well completions to a second well completions of the plurality of well completions; and
an output module stored in memory, executing on the computer processor, and configured to display the first well completion and the second well completion to a user.

11. The system of claim 10,
wherein the processing engine is further configured to:
calculate a first environmental profile KPI for the first well completion; and
wherein the output module is further configured to:
display the first environmental profile KPI to a user.

12. The system of claim 11,
wherein the processing engine is further configured to:
calculate a second profile KPI for the second well completion; and
wherein the output module is further configured to:
display the second environmental profile KPI and to the user.

13. The system of claim 10,
wherein the processing engine is further configured to:
monitoring an implementation of the first completion design to obtain real-time data; and
wherein the output module is further configured to:
provide the real-time data to the user.

14. The system of claim 10, further comprising:
an environmental profile KPI generator stored in memory, executing on the computer processor, and configured to calculate the plurality of environmental profile KPIs for the geographic location; and
an output module stored in memory, executing on the computer processor, and configured to display the plurality of environmental profile KPIs for the geographic location to a user.

15. The system of claim 14, wherein the output module is further configured to:
provide real-time data to the user.

16. The system of claim 14,
wherein the environmental profile KPI generator is further configured to:
compare a first environmental profile KPI of the plurality of environmental profile KPIs to a second environmental profile KPI of the plurality of environmental profile KPIs; and
wherein the input module is further configured to:
receive a selection by the user indicating the first environmental profile KPI.

17. The system of claim 10, further comprising a non-transitory computer readable medium storing instructions for calculating a plurality of environmental profile key performance indicators (KPIs) for a location, the instructions when executed causing a processor to:
receive a location data comprising a geographical location;
receive a first completion design comprising a first well design for enabling production at the geographical location;
calculate a first environmental profile KPI of the plurality of environmental profile KPIs using the first completion design and the location data; and
display the first environmental profile KPI to a user.

18. The system of claim 17, wherein the instructions when executed further causing a processor to:
calculate a second environmental profile KPI of the plurality of environmental profile KPIs using the second completion design and the location data; and
display the second environmental profile KPI and to the user.

19. The system of claim 17, wherein the instructions when executed further causing a processor to:
compare the first environmental profile KPI to the second environmental profile KPI; and
receiving a selection by the user indicating the first environmental profile KPI.

20. The system of claim 17, wherein the instructions when executed further causing a processor to:
monitor the production at the geographic location to obtain real-time data; and
provide the real-time data to the user.
